(19) United States
(12) Patent Application Publication
(10) Pub. No.: US 2007/0142258 A1
(43) Pub. Date: Jun. 21, 2007

(54) Method for producing alkylaryl compounds

(75) Inventors: Ulrich Steinbrenner, Neustadt (DE); Thomas Heidemann, Viernheim (DE); Michael Roper, Wachenheim (DE); Jurgen Stephan, Mannheim (DE); Thomas Narbeshuber, Mannheim (DE); Jurgen Tropsch, Romerberg (DE); Nils Bottke, Mannheim (DE); Regina Benfer, Altrip (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschft, Ludwigshafen (DE)

(21) Appl. No.: 10/583,140

(22) PCT Filed: Dec. 17, 2004
(86) PCT No.: PCT/EP04/14444

§ 371 Date: Jun. 16, 2006

(30) Foreign Application Priority Data
Dec. 19, 2003 (DE) 103 60 026.4

(51) Int. Cl. C09D 9/00

(52) U.S. Cl. 510/202

(57) ABSTRACT

The preparation of alkylaryl compounds takes place by
a) reaction of a C₄/C₅-olefin mixture over a metathesis catalyst to prepare a C₄₋₈-olefin mixture comprising 2-pentene, and optional removal of the C₄₋₈-olefin mixture, b) removal of from 5 to 100% of the 2-pentene present in stage a) and subsequent reaction over an isomerization catalyst to give a mixture of 2-pentene and 1-pentene which is returned to stage a),
c) dimerization of the C₄₋₈-olefin mixture obtained in stage b) following removal in the presence of a dimerization catalyst to give a mixture containing C₈₋₁₆-olefins, removal of these C₈₋₁₆-olefins and optional removal of a partial stream thereof,
d) reaction of the c₈₋₁₆-olefin mixtures obtained in stage c) or of the partial stream with an aromatic hydrocarbon in the presence of an alkylation catalyst to form alkyl aromatic compounds where, prior to the reaction, 0 to 60% by weight, based on the c₈₋₁₆-olefin mixtures obtained in stage c), of linear olefins may additionally be added, e) optional sulfonation of the alkyl aromatic compounds obtained in stage d) and neutralization to give alkylarylsulfonates, where, prior to the sulfonation, 0 to 60% by weight, based on the alkyl aromatic compounds obtained in stage d), of linear alkylbenzenes may additionally be added if no admixing has taken place in stage d), f) optional mixing of the alkylarylsulfonates obtained in stage e) with 0 to 60% by weight, based on the alkylarylsulfonates obtained in stage e), of linear alkylarylsulfonate, if no admixing has taken place in stages d) and e).

The present invention relates to processes for the preparation of alkylaryl compounds, in particular alkylarylsulfonates, to alkylaryls and alkylarylsulfonates obtainable by the process, to the use of the alkylarylsulfonates as surfactants, preferably in detergents and cleaners, and to detergents and cleaners comprising them.

Alkylbenzenesulfonates (ABS) have been used for a long time as surfactants in detergents and cleaners. Following the use initially of such surfactants based on tetrapropylene, which, however, had poor biodegradability, predominantly linear alkylbenzenesulfonates (LAS) have been prepared and used in the subsequent period. Linear alkylbenzenesulfonates, however, do not have property profiles which are adequate in all fields of use.

Thus, for example, it would be advantageous to improve their low-temperature washing properties or their properties in hard water. Likewise desirable is the ready ability to be formulated, which arises from the viscosity of the sulfonates and their solubility. These improved properties are achieved by slightly branched compounds or mixtures of slightly branched compounds with linear compounds, although the correct degree of branching and/or the correct degree of mixing must be achieved. Excessive branching impairs the biodegradability of the products. Products which are too linear adversely effect the viscosity and the solubility of the sulfonates.

Moreover, the proportion of terminal phenylalkanes (2-phenylalkanes and 3-phenylalkanes) relative to internal phenylalkanes 4-, 5-, 6- etc. phenylalkanes) plays a role for the product properties. A 2-phenyl content of about 30% and a 2- and 3-phenyl content of about 50% can be advantageous with regard to product quality (solubility, viscosity, washing products).

Surfactants with excessively high 2- and 3-phenyl contents can have the important disadvantage that the processability of the products suffers as a result of a large increase in the viscosity of the sulfonates.

Moreover, this may give rise to non-optimum solubility behavior. Thus, for example, the Krafft point of a solution of LAS with very high or very low 2- and 3-phenyl contents is around up to 10-20° C. higher than for the optimum choice of the 2- and 3-phenyl content.

The process according to the invention offers the important advantage that, by combining metathesis and dimerization with intermediate isomerization of 2-pentene, a unique olefin mixture is obtained which, following alkylation of an aromatic, sulfonation and neutralization, produces a surfactant which is characterized by its combination of excellent application properties (solubility, viscosity, stability toward water hardeners, washing properties, biodegradability). With regard to the biodegradability of the alkylarylsulfonates, compounds which are adsorbed to sewage sludge to a lesser extent than conventional LAS are particularly advantageous.

For this reason, alkylbenzenesulfonates branched to a certain degree have been developed.

WO 99/05241 relates to cleaners which comprise branched alkylarylsulfonates as surfactants. The alkylarylsulfonates are obtained by dimerization of olefins to give vinylidene olefins and subsequent alkylation of benzene over a shape-selective catalyst such as MOR or BEA. This is followed by a sulfonation.

WO 02/44114 relates to a process for the preparation of alkylarylsulfonates in which singly branched C₁₀₋₁₄-olefins obtainable by various processes are reacted with an aromatic hydrocarbon in the presence of zeolites of the faujasite type as alkylation catalyst. The C₁₀₋₁₄-olefins can be prepared, for example, by metathesis of a C₄-olefin mixture, followed by a dimerization of the resulting 2-pentene and/or 3-hexene over a dimerization catalyst. Alternative processes are extraction, Fischer-Tropsch synthesis, dimerization or isomerization of olefins.

WO 02/14266 relates to a process for the preparation of alkylarylsulfonates in which firstly a metathesis of a C₄-olefin mixture to prepare 2-pentene and/or 3-hexene is carried out, and the products are subjected to a dimerization. An alkylation is then carried out in the presence of an alkylation catalyst, followed by a sulfonation and neutralization.

The olefins used hitherto for the alkylation sometimes have too high or too low a degree of branching, or produce a non-optimum ratio of terminal to internal phenylalkanes. Secondly, they are prepared from expensive starting materials, such as, for example, propene or alpha-olefins, and in some cases the proportion of the olefin fractions of interest for the surfactant preparation is only about 20%. This leads to costly work-up steps. DE-A 102 61 481, which has an earlier priority and was unpublished at the priority date of the invention, relates to a process for the preparation of alkylarylsulfonates by
a) reaction of a C₄-olefin mixture over a metathesis catalyst to prepare a olefin mixture comprising 2-pentene and/or 3-hexene, and optional removal of 2-pentene and/or 3-hexene,
b) dimerization of the 2-pentene and/or 3-hexene obtained in stage a) in the presence of a dimerization catalyst to give a mixture comprising C₁₀₋₁₂-olefins, removal of the C₁₀₋₁₂-olefins and removal of 5 to 30% by weight, based on the C₁₀₋₁₂-Olefins removed, of low-boiling constituents of the C₁₀₋₁₂-olefins,
c) reaction of the C₁₀₋₁₂-olefin mixtures obtained in stage b) with an aromatic hydrocarbon in the presence of an alkylation catalyst to form alkyl aromatic compounds where, prior to the reaction, 0 to 60% by weight, preferably 0 to 40% by weight, based on the C₁₀₋₁₂-olefin mixtures obtained in stage b), of linear olefins may additionally be added,
d) sulfonation of the alkyl aromatic compounds obtained in stage c) and neutralization to give alkylarylsulfonates, where, prior to the sulfonation, 0 to 60% by weight, preferably 0 to 50% by weight, based on the alkyl aromatic compounds obtained in stage c), of linear alkylbenzenes may additionally be added, if no admixing has taken place in stage c),
e) optional mixing of the alkylarylsulfonates obtained in stage d) with 0 to 60% by weight, preferably 0 to 30% by weight, based on the alkylarylsulfonates obtained in stage d), of linear alkylarylsulfonates, if no admixing has taken place in stages c) and d).

The last-mentioned processes do not in all cases lead to products which display a desired spectrum of properties.

It is an object of the present invention to provide a process for the preparation of alkylaryl compounds, in particular alkylarylsulfonates, which are at least partially branched and thus have advantageous properties for use in detergents and cleaners compared with known compounds. In particular, they should have a suitable profile of properties of biodegradability, insensitivity toward water hardeners, solubility and viscosity during preparation and during use. In addition, the alkylarylsulfonates should be preparable in a cost-effective manner.

The object is achieved according to the invention by a process for the preparation of alkylaryl compounds by
a) reaction of a C₄/C₅-olefin mixture over a metathesis catalyst to prepare a C₄₋₈-olefin mixture comprising 2-pentene, and optional removal of the C₄₋₈-olefin mixture,
b) removal of from 5 to 100% of the 2-pentene present in stage a) and subsequent reaction over an isomerization catalyst to give a mixture of 2-pentene and 1-pentene which is returned to stage a),
c) dimerization of the C₄₋₈-olefin mixture obtained in stage b) following removal in the presence of a dimerization catalyst to give a mixture containing C₈₋₁₆-olefins, removal of these C₈₋₁₆-olefins and optional removal of a partial stream thereof,
d) reaction of the c₈₋₁₆-olefin mixtures obtained in stage c) or of the partial stream with an aromatic hydrocarbon in the presence of an alkylation catalyst to form alkyl aromatic compounds where, prior to the reaction, 0 to 60% by weight, based on the c₈₋₁₆-olefin mixtures obtained in stage c), of linear olefins may additionally be added,
e) optional sulfonation of the alkyl aromatic compounds obtained in stage d) and neutralization to give alkylarylsulfonates, where, prior to the sulfonation, 0 to 60% by weight, based on the alkyl aromatic compounds obtained in stage d), of linear alkylbenzenes may additionally be added if no admixing has taken place in stage d),
f) optional mixing of the alkylarylsulfonates obtained in stage e) with 0 to 60% by weight, based on the alkylarylsulfonates obtained in stage e), of linear alkylarylsulfonate, if no admixing has taken place in stages d) and

e). The combination of a metathesis of C₄/C₅-olefins with a subsequent isomerization of 2-pentene and dimerization and alkylation of aromatic hydrocarbons permits, under said conditions, the use of cost-effective starting materials and of preparation processes which make the desired products accessible in high yields.

It has been found according to the invention that the metathesis of C₄/C₅-olefins gives products which, following partial isomerization and recycling of 2-pentene, can be dimerized to give slightly branched C₈₋₁₆-olefin mixtures. By adjusting the desired degree of branching, for example by selective dimerization or removal of a partial stream and/or addition of linear olefins, these mixtures can be used advantageously in the alkylation of aromatic hydrocarbons, giving products which, following sulfonation and neutralization, produce surfactants which have excellent properties, in particular with regard to sensitivity toward hardness-forming ions, solubility of the sulfonates, viscosity of the sulfonates and their washing properties. Moreover, the present process is extremely cost-effective since the product streams can be arranged so flexibly that no bγ-products are produced. Starting a C₄ stream, following a first C₅ recycle starting then from a C₄/C₅ stream, the metathesis according to the invention produces linear, internal olefins which are then converted into branched olefins via the dimerization step.

Stage a) of the process according to the invention is the reaction of a C₄/C₅-olefin mixture over a metathesis catalyst to prepare a C₄₋₈-olefin mixture, and optional removal of C₄₋₈-olefins. The metathesis can be carried out, for example, as described in WO 00/39058 or DE-A-100 13 253.

The olefin metathesis (disproportionation) describes, in its simplest form, the reversible, metal-catalyzed transalkylidenation of olefins as a result of breakage or new formation of C═C double bonds in accordance with the following equation: 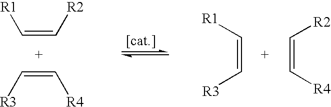
In the special case of the metathesis of acyclic olefins, a distinction is made between self-metathesis, in which an olefin converts to a mixture of two olefins of different molar mass (for example: propene→ethene+2-butene), and cross- or co-metathesis, which describes a reaction of two different olefins (propene+1-butene→ethene+2-pentene). If one of the reactors is ethene, then ethenolysis is generally the term used.

Suitable metathesis catalysts are in principle homogeneous and heterogeneous transition metal compounds, in particular those of sub-group VI to VIII of the Periodic Table of the Elements, and also homogeneous and heterogeneous catalyst systems in which these compounds are present.

Various metathesis processes which start from C₄ streams can be used according to the invention.

DE-A-1 99 32 060 relates to a process for the preparation of C₅-/C₆-olefins by reaction of a starting stream which comprises 1-butene, 2-butene and isobutene, to give a mixture of C₂₋₆-olefins. In the process, propene in particular is obtained from butenes. Additionally, hexene and methylpentene are discharged as products. In the metathesis, no ethene is added. Optionally, ethene formed in the metathesis is recycled to the reactor.

A preferred process for the preparation of optionally propene and hexene from a raffinate II starting stream comprising olefinic C₄ hydrocarbons comprises
a) in the presence of a metathesis catalyst, which comprises at least one compound of a metal of subgroup VIb, VIIb or VIII of the Periodic Table of the Elements, carrying out a metathesis reaction, in the course of which butenes present in the starting stream are reacted with ethene to give a mixture comprising ethene, propene, butenes, 2-pentene, 3-hexene and butanes, where, based on the butenes, up to 0.6 mol equivalents of ethene may be used,
b) separating the resulting exit stream initially by distillation into optionally a low-boiling fraction A comprising C₂-C₃-olefins, and also into a high-boiling fraction comprising C₄-C₆-olefins and butanes,
c) then separating the low-boiling fraction A optionally obtained from b) by distillation into an ethene-containing fraction and a propene-containing fraction, where the ethene-containing fraction is recycled to process step a) and the propene-containing fraction is discharged as product,
d) then separating the high-boiling fraction obtained from b) by distillation into a low-boiling fraction B comprising butenes and butanes, a medium-boiling fraction C comprising 2-pentene and into a high-boiling fraction D comprising 3-hexene,
e) where the fractions B and optionally C are completely or partially recycled to process step a), and fraction D and optionally C are discharged as product.

An alternative preferred process for the preparation of C₆-alkenes from a hydrocarbon stream comprising C₄-alkenes (starting stream C₄⁼) comprises
a) in a step a), bringing the stream C₄⁼ into contact with a metathesis catalyst which comprises at least one compound of a metal of subgroup VIb, VIIb or VIII of the Periodic Table of the Elements, where at least part of the C₄-alkenes is reacted to C₂-C₆-alkenes, and the material stream comprising the C₂-C₆-alkenes formed in the process (stream C₂₋₆⁼) is separated off from the metathesis catalyst,
b) in a step b), removing ethylene by distillation from the stream C₂₋₆⁼ and thus preparing a material stream comprising C₃- to C₆-alkenes (stream C₃₋₆⁼) and preparing a material stream consisting essentially of ethylene (stream C₂⁼),
c) in a step c), separating the stream C₃₋₆⁼ by distillation into a material stream consisting essentially of propylene (stream C₃⁼), a material stream consisting essentially of C₆-alkenes (stream C₆═) and one or more material streams, chosen from the following group: a material stream consisting essentially of C₄-alkenes (stream C₄⁼), a material stream consisting essentially of C₅-alkenes (stream C₅⁼) and a material stream consisting essentially of C₄- and C₅-alkenes (stream C₄₋₅⁼),
d) in a step d), using one or more material streams or parts thereof, chosen from the group stream C₄⁼, stream C₅⁼ and stream C₄₋₅⁼, completely or partially for the preparation of starting stream C₄⁼ (recycle stream), and optionally discharging the stream(s), or the part(s) thereof, which are not recycle stream.

The starting stream C₄⁼ is subjected here to a metathesis reaction in accordance with a process as described in EP-A 1069101.

The processes are carried out with the proviso of an addition of partially isomerized 2-pentene.

The metathesis reaction according to step a) is carried out here preferably in the presence of heterogeneous metathesis catalysts which are not or only slightly isomerization-active and which are chosen from the class of transition metal compounds of metals of group VIb, VIIb or VIII of the Periodic Table of the Elements applied to inorganic supports.

As metathesis catalyst, preference is given to using rhenium oxide on a support, preferably on γ-aluminum oxide or on Al₂O₃/B₂O₃/SiO₂ mixed supports.

In particular, the catalyst used is Re₂O₇/γ—Al₂O₃ with a rhenium oxide content of from 1 to 20% by weight, preferably 3 to 15% by weight, particularly preferably 6 to 12% by weight.

The metathesis is carried out in the liquid procedure preferably at a temperature of from 0 to 150° C., particularly preferably 20 to 80° C., and a pressure of from 2 to 200 bar, particularly preferably 5 to 30 bar.

If the metathesis is carried out in the gas phase, the temperature is preferably 20 to 300° C., particularly preferably 50 to 200° C. The pressure in this case is preferably 1 to 20 bar, particularly preferably 1 to 5 bar. Detailed information regarding the metathesis reaction is given again in EP-A 1069101.

The subsequent work-up of the stream C₂₋₆⁼ formed in the metathesis takes place in steps c) and d) described at the outset.

The individual streams and fractions can comprise said compounds/olefins or consist of them. In cases where they consist of these streams or compounds, the presence of relatively small amounts of other hydrocarbons cannot be ruled out.

In order to illustrate the process according to the invention in several variations in more detail, the reaction which takes place in the metathesis reactor is divided into three important individual reactions:
1. Cross-Metathesis of 1-butene with 2-butene 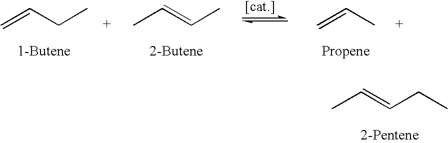
2. Self-Metathesis of 1-butene 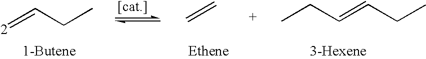
3. Optional Ethenolysis of 2-butene

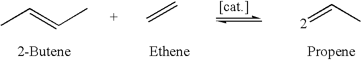

Recycling of the partially isomerized 2-pentene gives rise to further longer-chain products.

Depending on the particular requirement for the target products propene and hexene/heptene/octene (the term hexene etc. includes inter alia any isomers formed) or 2-pentene, the external mass balance of the process can be influenced in a targeted manner through the variable use of ethene and by shifting the equilibrium by recycling certain partial streams. Thus, for example, the 3-hexene yield can be increased by suppressing the cross-metathesis of 1-butene with 2-butene by recycling 2-pentene to the metathesis step, meaning that here no or the smallest possible amount of 1-butene is consumed. During the self-metathesis of 1-butene to 3-hexene which then preferably takes place, ethene is additionally formed which reacts in a subsequent reaction with 2-butene to give the product-of-value propene.

Olefin mixtures which comprise 1-butene and 2-butene and optionally isobutene are obtained inter alia in diverse cracking processes, such as steam cracking or FCC cracking, as C₄ fraction. Alternatively, it is possible to use butene mixtures as are produced in the dehydrogenation of butanes or by dimerization of ethene. Butanes present in the C₄ fraction have inert behavior. Dienes, alkynes or enynes are removed prior to the metathesis step according to the invention using customary methods such

as extraction or selective hydrogenation. The butene content of the C₄ fraction used in the process is 1 to 100% by weight, preferably 60 to 90% by weight. The butene content refers here to 1-butene, 2-butene and isobutene.

Preference is given to using a C₄ fraction as is produced during steam cracking or FCC cracking or during the dehydrogenation of butane.

Here, the C₄ fraction used is preferably raffinate II, where the C₄ stream is freed from troublesome impurities prior to the metathesis reaction by appropriate treatment over adsorber protection beds, preferably over high-surface-area aluminum oxides or molecular sieves.

In step d), the fractionation into low-boiling fraction B, medium-boiling fraction C and high-boiling fraction D can, for example, be carried out in a dividing-wall column. Here, the low-boiling fraction B is obtained overhead, the medium-boiling fraction C is obtained via a mid-discharge and the high-boiling fraction D is obtained as the bottom product.

5 to 100%, preferably 20 to 80%, in particular 40 to 60% of the 2-pentene obtained in stage a) is removed and subsequently converted to a mixture of 2-pentene and 1-pentene over an isomerization catalyst, with the resulting mixture being returned to stage a). As a result of this, butyl units are introduced into the metathesis in addition to the methylene, ethylene and propylene units, thus additionally giving rise to 2-hexene, 3-heptene and 4-octene as products. A mixture of butenes, pentenes, hexenes, heptenes and octenes is then drawn off from the metathesis/isomerization unit and introduced into the dimerization. Preferably, the stream comprises 0 to 10 mol % of butenes, 10 to 40% of pentenes, 60 to 80% of hexenes, 5 to 30% of heptenes and 0 to 15% of octenes, particularly preferably 0 to 5 mol % of butenes, 15 to 25% of pentenes, 60 to 75% of hexenes, 10 to 30% of heptenes and 0 to 10% of octenes, the total amount being 100 mol %.

The metathesis reaction is here preferably carried out in the presence of heterogeneous metathesis catalysts which are not or only slightly isomerization-active and which are chosen from the class of transition metal compounds of metals of group VIb, VIIb or VIII of the Periodic Table of the Elements applied to inorganic supports.

Preferably, the metathesis catalyst used is rhenium oxide on a support, preferably on γ-aluminum oxide or on Al₂O₃/B₂O₃/SiO₂ mixed supports.

In particular, the catalyst used is Re₂O₇/γ—Al₂O₃ with a rhenium oxide content of from 1 to 20% by weight, preferably 3 to 15% by weight, particularly preferably 6 to 12% by weight.

The metathesis is carried out in the liquid procedure preferably at a temperature of from 0 to 150° C., particularly preferably 20 to 110° C., and a pressure of from 2 to 200 bar, particularly preferably 5 to 40 bar.

If the metathesis is carried out in the gas phase, the temperature is preferably 20 to 300° C., particularly preferably 50 to 200° C. The pressure in this case is preferably 1 to 20 bar, particularly preferably 1 to 5 bar.

To improve the cycle life of the catalysts used, primarily of the supported catalysts, the use of a feed purification over adsorber beds (guard beds) is recommended. The guard bed serves here to dry the C₄C₅ stream and to remove substances which may act as catalyst poison in the subsequent metathesis step. The preferred adsorber materials are Selexsorb CD and CDO and also 3 Å and NaX molecular sieves (13×). The purification takes place in drying towers at temperatures and pressures which are preferably chosen such that all of the components are present in the liquid phase. Optionally, the purification step is used for prewarming the feed for the subsequent metathesis step. It may be advantageous to combine or connect in series two or more purification steps.

Pressure and temperature in the metathesis step are chosen such that all of the reactants are in the liquid phase (usually=0 to 150° C., preferably 20 to 80° C.; p=2 to 200 bar). Alternatively, though, it may be advantageous, particularly in the case of feed streams with a relatively high isobutene content, to carry out the reaction in the gas phase and/or to use a catalyst which has a lower acidity.

As a rule, the reaction is complete after 1 s to 1 h, preferably after 30 s to 30 min. It can be carried out continuously or batchwise in reactors, such as pressurized gas vessels, flow tubes or reactive distillation devices, preference being given to flow tubes.

Stage b)

In stage b), some of the 2-pentene obtained in stage a) is removed, converted to a mixture of 2-pentene and 1-pentene over an isomerization catalyst, and the resulting mixture is returned to stage a).

The isomerization of 2-pentene to 1-pentene is an equilibrium reaction. Cis-2-pentene, trans-2-pentene and 1-pentene are present in equilibrium. The reaction of 2-pentene to 1-pentene is weakly endothermic, meaning that a temperature increase shifts the equilibrium in the direction of 1-pentene. The thermodynamic data are given in D. Stull, “The Chemical Thermodynamics of Organic Compounds”, J. Wiley, New York 1969.

The isomerization preferably takes place at temperatures between 100 and 500° C. The choice of isomerization catalyst is not further limited provided it is capable of bringing about the intended isomerization. For example, basic catalysts or catalysts based on zeolite are used for this purpose, the isomerization can in addition also be carried out under hydrogenating conditions over noble metal-containing catalysts.

Specifically, EP-A 0 718 036 describes the use of alkaline earth metal oxides on aluminum oxide as catalyst. DE-A 33 190 99 lists catalysts based on mixed aluminum oxide/silicon oxide supports which have been doped with oxides of the alkaline earth metals, boron group metals, lanthanides or elements of the iron group. EP-A 0 419 630 discloses a catalyst which is prepared from polymorphous magnesium/aluminum oxides. A gamma-aluminum oxide impregnated with alkali is disclosed in JP 57043055 as double-bond isomerization catalyst. An isomerization catalyst consisting of manganese oxide on aluminum oxide is found in U.S. Pat. No. 4,289,919. EP-A 0 234 498 describes an isomerization catalyst of the oxides of magnesium, alkali metal and zirconium dispersed on an aluminum support. An aluminum oxide catalyst which additionally comprises sodium oxide and silicon oxide is taught in U.S. Pat. No. 4,229,610.

Examples of zeolite-based catalysts are found, for example, in EP-A 0 129 899, which teaches the use of zeolites of the pentasil type. Molecular sieves exchanged with alkali metals or alkaline earth metals are described in U.S. Pat. No. 3,475,511. U.S. Pat. No. 4,749,819 mentions the use of alumosilicates with an 8- or 10-ring channel structure as double-bond isomerization catalysts. Zeolites in the alkali metal or alkaline earth metal form are disclosed in U.S. Pat. No. 4,992,613. Catalysts based on crystalline borosilicates are described in U.S. Pat. No. 4,499,326.

Stage c)

In stage c) the C₄/C₅-olefin mixture obtained in stage b) is dimerized in the presence of a dimerization catalyst to give a C₈₋₁₆-olefin mixture.

The resulting dimer olefin mixtures according to the invention preferably have an average degree of branching in the range from 1 to 2.5, particularly preferably 1 to 2.0, in particular 1 to 1.5 and specifically 1 to 1.2. The degree of branching of a pure olefin is defined here as the number of carbon atoms which are linked to three carbon atoms, plus two times the number of carbon atoms which are linked to 4 carbon atoms. The degree of branching of a pure olefin can be measured here readily following total hydrogenation to the alkane via ¹H NMR via the integration of the signals of the methyl groups relative to the methylene and methine protons.

For mixtures of olefins, the degrees of branching are weighted with the molar percentages, and thus an average degree of branching is calculated.

The molar fractions are determined here ideally by means of gas chromatography.

The type of branching in the olefin is preferably such that, following hydrogenation, less than 10%, preferably less than 5%, particularly preferably less than 1%, of alkanes are obtained which do not belong to the methyl-, dimethyl-, ethylmethyl- and diethylalkanes. This means that the branches are only methyl and ethyl branches.

According to a particularly preferred embodiment of the invention, the dimerization is carried out such that the catalysis produces directly the desired advantageous composition relative to the branching structures.

C₈₋₁₆-olefins are formed in the dimerization. From this stream is preferably separated off a partial stream (59 to 99 mol % of the total stream) comprising preferably less than 5 mol % of C_{<10}, 5 to 15% of C₁₀, 35 to 55% of C₁₁, 25 to 45% of C₁₂, 5 to 15% of C₁₃ and <5% of C_{>13}, preferably <2 mol % of C_{<10}, 5 to 15% of C₁₀, 40 to 50% of C₁₁, 30 to 50% of C₁₂, 5 to 15% of C₁₃ and <2% of C_{>13}. The sum is 100 mol %. Preferably the stream into the isomerization unit is chosen such that, after the isomerization, >70%, preferably, >80%, of product of value according to the composition given above results.

This olefin stream is then used for the alkylation in stage d).

According to a further embodiment of the invention, the resulting C₈₋₁₆-olefins are removed and 5 to 30% by weight, preferably 5 to 20% by weight, in particular up to 10 to 20% by weight, based on the removed C₈₋₁₆-olefins, of low-boiling constituents of the C₈₋₁₆-olefins are removed. Low-boiling constituents is the term used for the fraction of the C₈₋₁₆-olefin mixture which, during distillation, passes over first or has the lowest boiling point. Said weight fraction thus corresponds to the fraction which, during distillation, passes over first and can thus be separated off. Removal can, however, also take place via any other suitable methods. In particular, fractional distillation is carried out. As a result of the separation carried out in accordance with the invention, the polybranched olefins are removed in part or preferably in their entirety from the C₈₋₁₆-olefin mixture. The removal can also be carried out such that at least 80%, preferably at least 90%, in particular at least 95% of the di- or polybranched olefins are separated off. In the C₈₋₁₆-olefin mixture at the end of stage c), the linear and singly branched olefins and possibly lower fractions of polybranched olefins thus remain. Suitable separation methods and analytical methods for determining the content of polybranched olefins are known to the person skilled in the art.

Said embodiments can be combined with the addition of linear olefins in stage d), linear alkylbenzenes in stage e), linear alkylarylsulfonates in stage f) or combinations thereof.

It is, however, also possible to dispense with an addition of such linear compounds. If linear compounds are added in stages d), e) and/or f), then, according to one embodiment, it is possible to dispense with separating off low-boiling constituents in stage c).

In the dimerization mixture, <30, preferably <10% by weight of alkanes and <5% by weight of non-C₈₋₁₆-olefins may be present.

Preferably, the internal, linear pentenes, hexenes, heptenes and octenes present in the metathesis product are used for the dimerization.

The dimerization can be carried out with homogeneous catalysis or heterogeneous catalysis. The homogeneously catalyzed dimerization can be varied within wide limits relative to the branching structures. As well as nickel systems, it is also possible to use, for example, Ti, Zr, Cr or Fe systems, which can be modified in a targeted manner via further cocatalysts and ligands.

The homogeneously catalyzed dimerization in the absence of transition metals is particularly preferably catalyzed with aluminum alkyls AlR₃. While these α-olefins react selectively to vinylidenes under very mild conditions, the corresponding reaction of internal olefins is also possible under more drastic conditions. Here too, dimers with a high vinylidene content are formed. The proportion of di- and triple-branched isomers is extremely low.

The AlR₃-catalyzed dimerization is preferably carried out at temperatures in the range from 150 to 300° C., particularly preferably 180 to 240° C., in particular 210 to 230° C., the catalyst is preferably separated off by distillation via the still and recycled to the catalysis.

For the heterogeneous catalysis, use is expediently made of combinations of oxides of metals of subgroup VIII with aluminum oxide on support materials of silicon and titanium oxides, as are known, for example, from DE-A-43 39 713. The heterogeneous catalyst can be used in a fixed bed (then preferably in coarsely particulate form as 1 to 1.5 mm chips) or in suspended form (particle size 0.05 to 0.5 mm). The dimerization is carried out in the case of the heterogeneous procedure expediently at temperatures of from 80 to 200° C., preferably from 100 to 180° C., under the pressure prevailing at the reaction temperature, optionally also under a protective gas at a pressure above atmospheric pressure, in a closed system. To achieve optimum conversions, the reaction mixture is repeatedly cycled, a certain fraction of the circulating product being discharged and replaced by starting material continuously.

In the dimerization according to the invention, mixtures of monounsaturated hydrocarbons are obtained whose components predominantly have a chain length which is twice that of the starting olefins.

In C₁₂-olefin mixtures prepared according to the invention, the main chain preferably carries methyl or ethyl groups at the branching points.

The olefin mixtures obtainable by the above process (cf. WO 00/39058) represent valuable intermediates, in particular for the preparation, described below, of branched alkyl aromatics for the preparation of surfactants.

Stage d)

In stage d) the C₈₋₁₆-olefin mixture obtained in stage c) is reacted with an aromatic hydrocarbon in the presence of an alkylating catalyst to form alkyl aromatic compounds.

The C₈₋₁₆-olefin mixture used in stage d) has an optimum structure/linearity. This means that the degree of branching and the type of branching are optimally chosen in order to obtain advantageous alkyl aromatic compounds in stage d). The adjustment of the C₈₋₁₆-olefin mixture to be used optimally in stage d) can take place by admixing linear olefins. Preferably, however, more highly branched olefins are separated off instead of an admixing of linear olefins. Particularly preferably, in the dimerization, a suitable catalyst is combined with a suitable processing method in order to obtain the optimum C₈₋₁₆-olefin mixture. In this processing method, the desired structures are obtained directly in the alkylation. In this case, it is possible to dispense with the admixing of linear olefins and the removal of more highly branched olefins. Combinations of the processing methods described are also possible.

If in stage c) a removal of low-boiling components is carried out, in stage d) 0 to 60% by weight, preferably 0 to 50% by weight, in particular 0 to 30% by weight, based on the C₈₋₁₆-olefin mixtures obtained in stage c), of linear olefins can be added if desired. If linear olefins are added, their amount is at least 1% by weight, preferably at least 5% by weight, in particular at least 10% by weight.

If, according to the second embodiment of the invention, no removal of low-boiling components is carried out in stage c), in at least one of stages d), e) and f) 5 to 60% by weight, in each case based on the mixtures obtained in the previous stage, of the linear compounds are added. This means that in stage d) additionally linear olefins are added and/or in stage e) additionally linear alkylbenzenes are added and/or in stage e) additionally linear alkylarylsulfonates are added. Thus, linear compounds can be added in each of the stages c), d) and e), and also in individual stages or in two of these stages. In stage c) 5 to 60% by weight, preferably 10 to 50% by weight, in particular 10 to 30% by weight, based on the C₀₋₁₂-olefin mixtures obtained in stage c), of linear olefins can thus be added.

Based on stages d), e) and f) overall, preferably at most 60% by weight, particularly preferably at most 40% by weight, in particular at most 30% by weight, of the linear compounds are added. If this maximum amount is already achieved by the addition in one of these stages, in the other stages an addition of linear compounds is dispensed with.

As a result of the addition of the linear compounds, the profile of properties of the alkylarylsulfonates can be adapted over and above the advantageous synthesis sequence to the respective desired field of application and the profile of requirements.

The lower limits mentioned in each case can be combined with the upper limits mentioned in each case to give ranges which are possible according to the invention.

Thus, preference is given to using an alkylation catalyst which leads to alkyl aromatic compounds which have one to three carbon atoms with an H/C index of 1 in the alkyl radical.

The alkylation can in principle be carried out in the presence of any alkylation catalysts.

Although AlCl₃ and HF can be used in principle, heterogeneous or shape-selective catalysts offer advantages. For reasons of plant safety and environmental protection, preference is nowadays given to solid catalysts, which include, for example, the fluorinated Si/Al catalyst used in the DETAL process, a number of shape-selective catalysts and supported metal oxide catalysts, and also phyllosilicates and clays.

In the choice of catalyst, despite the large influence of the feedstock used, an important aspect is to minimize compounds formed by the catalyst which are notable for the fact that they include C atoms with an H/C index of 0 in the alkyl radical. Furthermore, compounds should be formed which on average have 1 to 3 C atoms with an H/C index of 1 in the alkyl radical. This can be achieved, in particular, through the choice of suitable catalysts which, on the one hand, suppress the formation of the undesired products as a result of their geometry, but on the other hand permit an adequate reaction rate.

The alkyl aromatic compounds according to the invention have a characteristic content of primary, secondary, tertiary and quaternary carbon atoms in the alkyl radical (side chain). This is reflected in the number of carbon atoms in the alkyl radical with an H/C index of from 0 to 3. The H/C index defines here the number of protons per carbon atom in the alkyl radical. Preferably, the mixtures of alkyl aromatic compounds according to the invention have only a small fraction of carbon atoms in the alkyl radical with an H/C index of 0. Preferably, the fraction of carbon atoms in the alkyl radical with an H/C index of 0 is, from an average of all compounds, <15%, particularly preferably <10%. The fraction of carbon atoms in the alkyl radical with an H/C index of 0 which are simultaneously bonded to the aromatics is >80%, preferably >90%, particularly preferably >95% of all carbon atoms in the alkyl radical with an H/C index of 0.

Preferably, the mixtures of alkyl aromatic compounds according to the invention have on average 1 to 3, preferably 1 to 2.5, particularly preferably 1 to 2, carbon atoms in the side chain (i.e. without counting the aromatic carbon atoms) with an H/C index of 1.

The proportion of compounds with three carbon atoms of this type is preferably <30%, particularly preferably <20%, in particular <10%.

The fraction of carbon atoms which have a certain H/C index can be controlled through appropriate choice of the catalyst used. Preferably used catalysts with which advantageous H/C distributions are achieved are mordenite, β-zeolite, L-zeolite, MCM-58, MCM-68 and faujasite. Particular preference is given to mordenite and faujasite.

In choosing the catalysts, their tendency with regard to deactivation must moreover be taken into consideration. One-dimensional pore systems in most cases have the disadvantage of rapid blockage of the pores by degradation products or synthesis products from the process. Catalysts with polydimensional pore systems are therefore preferred.

The catalysts used can be of natural or synthetic origin, whose properties can be adjusted by methods known from the literature (e.g. ion exchange, steaming, blocking of acid centers, washing out of extralattice species, etc.) to a certain extent. It is important for the present invention that the catalysts at least partially have acidic character.

Depending on the type of application, the catalysts are either in the form of powders or moldings. The linkages of the matrices of the moldings ensure adequate mechanical stability, although free access of the molecules to the active constituents of the catalysts is to be ensured through adequate porosity of the matrices. The preparation of such moldings is known in the literature and is carried out in accordance with the prior art.

Preferred Reaction Procedure

The alkylation is carried out by reacting the aromatic (the aromatic mixture) and the olefin (mixture) in a suitable reaction zone by bringing them into contact with the catalyst, working up the reaction mixture after the reaction and thus obtaining the products of value.

Suitable reaction zones are, for example, tubular reactors or stirred-tank reactors. If the catalyst is in solid form, then it can be used either as a slurry, as a fixed bed or as a fluidized bed. Execution as a catalytic distillation is also possible.

The reactants are either in the liquid and/or in the gaseous state.

The reaction temperature is chosen such that on the one hand as complete as possible a conversion of the olefin takes place and on the other hand the fewest possible b-products are formed. The choice of temperature control also depends decisively on the catalyst chosen. Reaction temperatures between 50° C. and 500° C. (preferably 80 to 350° C., particularly preferably 80-250° C.) can be used.

The pressure of the reaction is governed by the procedure chosen (reactor type) and is between 0.1 and 100 bar, the weight hourly space velocity (WHSV) is chosen between 0.1 and 100. The procedure is generally carried out under intrinsic pressure (the vapor pressure of the system) or above.

The reactants can optionally be diluted with inert substances. Inert substances are preferably paraffins.

The molar ratio of aromatic:olefin is usually adjusted between 1:1 and 100:1 (preferably 2:1-20:1).

Aromatic Feed Substances

Possible substances are all aromatic hydrocarbons of the formula Ar—R, where Ar is a monocyclic or bicyclic aromatic hydrocarbon radical, and R is chosen from H, C₁₋₅ preferably C₁₋₃-alkyl, OH, OR etc., preferably H or C₁₋₃-alkyl. Preference is given to benzene and toluene.

Stage e)

In stage e) the alkyl aromatic compounds obtained in stage d) are sulfonated and neutralized to give alkylarylsulfonates.

The alkylaryls are converted to alkylarylsulfonates by
1) sulfonation (e.g. with SO₃, oleum, chlorosulfonic acid, etc., preferably with SO₃) and
2) neutralization (e.g. with Na, K, NH₄, Mg compounds, preferably with Na compounds).

Sulfonation and neutralization are described adequately in the literature and are carried out in accordance with the prior art. The sulfonation is preferably carried out in a falling-film reactor, but can also take place in a stirred-tank reactor. The sulfonation with SO₃ is preferred over the sulfonation with oleum.

Mixtures

The compounds prepared by processes described above are either further processed as they are, or mixed beforehand with linear alkylaryls and then passed for further processing. In order to simplify this process, it may also be advisable to mix the raw materials which are used for the preparation of the abovementioned other alkylaryls directly with the raw materials of the present process and then to carry out the process according to the invention. Thus, for example, as described, the mixing of slightly branched olefin streams from the process according to the invention with linear olefins is advisable. Mixtures of the alkylarylsulfonic acids or of the alkylarylsulfonates can also be used. The mixings are always carried out with regard to the optimization of the product quality of the surfactants prepared from the alkylaryl.

In stage e) linear alkylbenzenes can additionally be added prior to the sulfonation. Their amount is 0 to 60% by weight, preferably 0 to 50% by weight, in particular 0 to 30% by weight. If no removal of low-boiling constituents is carried out in stage c), and no addition of linear compounds takes place in stages d) and f), the minimum amount is 5% by weight, preferably 10% by weight. Reference is made to the above statements regarding the total amount of the linear compounds added. In the linear alkylbenzenes, the chain length of the alkyl radicals preferably corresponds to the chain length of the alkyl radicals as is obtained from stage c) in the alkyl aromatic compounds. Preferably linear (C₁₀-alkyl)benzenes are added to (C₁₀-alkyl)benzenes and correspondingly linear (C₁₂-alkyl)benzenes are added to (C₁₂-alkyl)benzenes.

An exemplary overview of alkylation, sulfonation, neutralization is given, for example, in “Alkylarylsulfonates: History, Manufacture, Analysis and Environmental Properties” in Surf. Sci. Ser. 56 (1996) Chapter 2, Marcel Dekker, New York and references contained therein.

Stage f)

In stage f) the alkylarylsulfonates present in stage e) can additionally be mixed with linear alkylarylsulfonates.

In stage f) preferably 0 to 60% by weight, particularly preferably 0 to 50% by weight, in particular 0 to 30% by weight, of linear alkylarylsulfonates are added. If no removal of low-boiling constituents takes place in stage c), and no addition of linear compounds takes place in stages d) and e), the minimum amount is preferably 5% by weight, preferably at least 10% by weight. Reference is made to the abovementioned preferred total amounts for the addition of linear compounds.

All of the weight data refer in each case to the mixtures obtained in the preceding stage.

The invention also provides alkylarylsulfonates obtainable by a process as described above.

The alkylarylsulfonates according to the invention are preferably used as surfactants, in particular in detergents and cleaners. The invention also provides a detergent or cleaner comprising, as well as customary ingredients, alkylarylsulfonates as described above.

Non-limiting examples of customary ingredients of the detergents and cleaners according to the invention are listed, for example, in WO 02/44114 and WO 02/14266.

1. A process for the preparation of alkylaryl compounds comprising:
a) reacting a C₄/C₅-olefin mixture over a metathesis catalyst to prepare a C₄₋₈-olefin mixture comprising 2-pentene, and optionally removing the C₄₋₈-olefin mixture,
b) removing from 5 to 100% of the 2-pentene present in stage a) and subsequently reacting over an isomerization catalyst to give a mixture of 2-pentene and 1-pentene which is returned to stage a),
c) dimerizing the C₄₋₈-olefin mixture obtained in stage b) following removal in the presence of a dimerization catalyst to give a mixture containing C₈₋₁₆-olefins, removing these C₈₋₁₆-olefins and optional removal of optionally removing a partial stream thereof,
d) reacting the C₈₋₁₆-olefin mixtures obtained in stage c) or the partial stream with an aromatic hydrocarbon in the presence of an alkylation catalyst to form alkyl aromatic compounds where, prior to the reaction, 0 to 60% by weight, based on the C₈₋₁₆-olefin mixtures obtained in stage c), of linear olefins may additionally be added,
e) optionally sulfonating the alkyl aromatic compounds obtained in stage d) and neutralizing to give alkylarylsulfonates, where, prior to the sulfonation, 0 to 60% by weight, based on the alkyl aromatic compounds obtained in stage d), of linear alkylbenzenes may additionally be added if no admixing has taken place in stage d), and
f) optionally mixing the alkylarylsulfonates obtained in stage e) with 0 to 60% by weight, based on the alkylarylsulfonates obtained in stage e), of linear alkylarylsulfonate, if no admixing has taken place in stages d) and e).

2. The process according to claim 1, wherein, in at least one of stages d), e) and f), 5 to 60% by weight, in each case based on the mixtures present in the preceding stage, of the linear compounds are added, and the sum of the additions is not more than 80% by weight.

3. The process according to claim 1, wherein the metathesis catalyst in stage a) is chosen from compounds of a metal of group VIb, VIb or sub-group VIII of the Periodic Table of the Elements and/or, in stage b), a dimerization catalyst is used comprising at least one element of sub-group VIII of the Periodic Table of the Elements.

4. The process according to claim 1, wherein the dimer-olefin mixtures obtained in stage b) have an average degree of branching in the range from 1 to 2.5.

5. The process according to claim 1, wherein the C₄₋₈-olefin mixture introduced into stage c) comprises 0 to 10 mol % of butenes, 10 to 40 mol % of pentenes, 60 to 80 mol % of hexenes, 5 to 30 mol % of heptenes and 0 to 15 mol % of octenes, the total amount of which is 100 mol %.

6. The process according to claim 1, wherein the C₁₋₁₆-olefin mixture introduced into stage d) and/or the partial stream comprises less than 5 mol % of C_{<10}-olefins, 5 to 15 mol-% of C₁₀-olefins, 35 to 55 mol % of C₁₁-olefins, 25 to 45 mol % of C₁₂-olefins, 5 to 15 mol % of C₁₃-olefins and less than 5 mol % of C_{>13}-olefins, the total amount of which is 100 mol %.

7. The process according to claim 1, wherein, in stage c), an alkylation catalyst is used that leads to alkyl aromatic compounds that have 1 to 3 carbon atoms with an H/C index of 1 in the alkyl radical.

8. An alkylaryl or alkylarylsulfonate obtained by a process according to claim 1.

9. A method comprising the use of surfactants, comprising using the alkylarylsulfonates according to claim 8 as surfactants.

10. A detergent or cleaner comprising, besides customary ingredients, alkylarylsulfonates according to claim 8.
